(19) United States
(12) Patent Application Publication
(10) Pub. No.: US 2008/0281706 A1
(43) Pub. Date: Nov. 13, 2008

(54) Systems and Methods for Delivering Affinity or Loyalty Reward Programs to Network Subscribers

(76) Inventor: Alan T. Sullivan, Leesburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/065,759

(22) PCT Filed: Sep. 5, 2006
(86) PCT No.: PCT/US06/34672

§ 371 Date: Jul. 16, 2008

Related U.S. Application Data
(60) Provisional application No. 60/713,753, filed on Sep. 6, 2005.

(51) Int. Cl. G06Q 30/00; G06Q 99/00

(52) U.S. Cl. 705/14; 705/1

(57) ABSTRACT

The present invention provides a system and method for an affinity rewards program, also called a loyalty rewards program, that is administered by an Internet Service Provider (ISP). The system and method of the invention, as implemented by an ISP, provide many advantages over current affinity programs, which are administered by third party providers as distinct services from the services provided by ISPs. Among the advantages to the ISP subscribers are ease of use and ease of determining best prices for goods and services. Among the advantages to the ISP is an increase in subscribers and an increase in subscriber loyalty and satisfaction. Among the advantages to retailers is an increase in traffic at web sites, an increase in sales over the Internet, and an increase in the ability to personally market to program participants.

### CROSS-REFERENCE TO RELATED APPLICATIONS

This application relies on and claims the benefit of the filing date of U.S. provisional patent application number 60/713,753, filed on 6 Sep. 2005, the entire disclosure of which is hereby incorporated herein in its entirety by reference.

### BACKGROUND OF THE INVENTION

1. Field of the Invention

The present invention relates to the fields of electronic communication and doing business using computers. More specifically, the present invention relates to systems and methods for monitoring Internet traffic and providing information to subscribers of networks that is relevant and specific to those subscribers. In particular, the invention provides an affinity program administered through an Internet Service Provider (ISP) for the customers of the ISP.

2. Description of Related Art

Internet commerce is a rapidly growing segment of the U.S. and world-wide economies. Purchasing products over the Internet is occurring at an increasing frequency, with classic brick-and-mortar stores losing market share to such purchasing. Consumers are becoming more and more comfortable with Internet shopping, and often prefer the convenience and speed with which purchases can be made on-line.

In view of the rapid increase in volume of business being conducted over the Internet, and particularly the amount of purchases of consumer goods, competition among merchants for consumers has become fierce. Discounts, sometimes deep discounts, for on-line purchases are being offered by retailers. One type of discount being offered is a discount for return or preferred shoppers. To this end, a niche market for “affinity” or “loyalty” programs has developed. This type of service discounting system provides monetary discounts on items purchased by members of the loyalty program or awards points that can be used on future purchases from the retailer. Monetary rewards are typically given to both the purchaser and the manager of the affinity program.

Most loyalty or affinity programs require that the consumer log in to a central site (e.g., a Fatwallet.com, ClickRewards.com, MyPoints.com) provided by the program manager, and click through to a participating retailer from that site. Thus, if a subscriber to one of these loyalty programs is product and price shopping over the Internet and finds a product of interest at a retailer's web site, that subscriber must leave the particular web site, enter the loyalty program manager's web site, find the appropriate link to the retailer's site, and re-enter the retailer's site through the portal provided by the affinity program manager. Many loyalty programs provide discounts only on certain items or at certain times (e.g., when there is an overstock at the manufacturer's plant or warehouse). Thus, upon return to the retailer's web site, the Internet shopper might find that there is no discount on the item of interest at that time. For an Internet shopper looking for an item that is available from numerous retailers, this scenario could be played out numerous times, the net result being that the consumer becomes frustrated with Internet shopping and the loyalty program.

Surveys have shown that loyalty programs that provide monetary benefits to Internet shoppers do, in fact, engender loyalty among shoppers, and thus enhance the profits of retailers who participate in the programs. It is well known that it is much easier and less costly to retain a customer than to market to and attract a new customer. Thus, retailers that provide consistently positive experiences for customers are more likely to retain those customers than retailers who do not. Unfortunately for retailers, poor experiences due to the limitations of affinity programs, such as the scenario discussed above, reflects poorly not only on the program provider, but on the retailer as well.

It has been reported that one drawback to Internet users shopping directly at retailer's web sites on the Internet is the time and effort required to initially enter the site. Sites typically require shoppers to enter personally-identifying information, such as name, address, phone number, and the like before a shopper is permitted to purchase on-line from the retailer's site. One advantage to loyalty programs is that the user is required to enter personally-identifying information only once (at the program manager's site) per session, rather than enter that information (which might be different for each site) at each retailer's site that is visited. However, if a user is a member of multiple affinity programs so as to be able to find the absolute best discount at any one time, the user must log in to each site with personally identifying information.

As use of the Internet for shopping has grown, various solutions to the drawbacks discussed above have been proposed. For example, U.S. patent application publication No. 2004/0267610 to Gossett et al. describes hardware and software to implement an affiliate program, which can be implemented by an ISP. The hardware and software analyze requests for web sites submitted by ISP customers, determine if the web site is operated by a member of an affiliate program, and, if so, redirect the request through the affiliate program. In this way, the ISP customer is provided with the benefits of the affiliate program and the ISP gets credit for funneling traffic through the program. According to the application's disclosure, a comparison of the requested Uniform Resource Locator (URL) with a database of URLs representing affiliate members is performed at the ISP, and, if the requested URL represents a site of an affiliate member, the URL request is changed to specify a different site or page, which is a site or page maintained by the affiliate member of the affiliate program, for which the original request was made. By replacing the URL request with a request for a page within the affiliate program, the ISP receives pay-for-performance credits and the requestor gets the benefits (if any) of the affiliate program. In other embodiments, the URL request is not changed, but additional information is added to inform the web site owner that the user has been referred to his site by the ISP. However, the system disclosed in this patent application publication, while quite useful, is capable of directing a user only to a single web page of interest in response to a request, and is limited by the number of affiliates in the program.

Although advances have been made in providing affinity or loyalty programs, there exists a need in the art to provide Internet shoppers a system for obtaining preferentially discounted prices on goods and services through commercial retailers using such programs. The system should provide the discounts available from retailers through affinity programs, but should be more user friendly and allow comparison shopping and program purchasing at the program's discount rate, without the need to return to the affinity program manager's site each time a new retailer's web site is to be visited, or to re-submit a specific web page request for each affiliate of interest.

### SUMMARY OF THE INVENTION

The present invention provides solutions to needs in the art by providing a system and method for providing a loyalty program to Internet shoppers. The present invention also provides a method of doing business using computers, and particularly a method of doing business over the Internet, which provides customers a convenient way to comparison shop and purchase goods and services over the Internet, while at the same time providing retailers and service providers a powerful method of attracting and retaining customers, and thus a method of generating revenue. In general, the invention provides an affinity program implemented through a network, such as at the ISP level of the Internet, through an enterprise network, or any other institution that provides Internet access. The affinity program allows for these services providers to provide their subscribers access to one or more affinity networks in a seamless fashion as a service of the provider (e.g., ISP). For the purpose of simplicity herein, all such service providers are referred to as “ISP”, although it should be recognized that certain differences exist in the business structure and services provided by various Internet access providers. The use of “ISP” should not be considered as limiting the disclosure to only those entities that are generally considered under that term, but should, for the purposes of this document, be broadly understood unless otherwise specifically limited.

The present invention provides a system whereby a subscriber to an ISP can participate in one or multiple affinity programs simply by subscribing to the ISP. That is, the present invention provides affinity programs that are administered by ISPs rather than by stand-alone, third party providers. Providing the affinity program as a service of the ISP eliminates the need for the subscriber (also referred to herein as the user or the shopper) to locate a suitable affinity program manager from the many available on the Internet, and avoids the need for that subscriber to enter personally-identifying information on the program manager's web site. It also provides advantages over other proposed solutions, such as those discussed above, by allowing a user to access multiple retailers (also referred to herein as advertisers) through a single search, rather than requiring the user to request a specific URL for each retailer of interest. In contrast to other systems and proposed systems in the art, information for the affinity program of the present invention is culled from information provided to the ISP at the time of signing up for the ISP services, or through other means, as discussed below. In essence, the present invention generally provides an ISP as an affinity program provider, with the resultant advantages to the ISP subscriber and ISP.

In general, in a first aspect, the invention provides a method of providing an affinity or loyalty program. In general terms, the method comprises, in any order deemed advantageous: obtaining or generating one or more piece of identifying information for a user; providing the user access to one or more affinity programs; and providing the user results for a search for one or more products or services from affinity program advertisers. The method can further comprise providing the user with Internet access outside of the context of the affinity program, such as through general services provided by an ISP. Typically, the identifying information is provided by the user or obtained from the user only a single time, and is retrieved automatically upon return of the user for subsequent search sessions. In a preferred embodiment, the method further comprises creating a landing page to display the results of a search, where the landing page may comprise results from one or more affinity networks and/or advertising content or other content that might be of interest to the user. In embodiments, the method is implemented by way of computer software.

In a second aspect, one or more pieces of computer hardware are provided. The hardware can comprise any number of components, but in general, comprises a processor for implementing the method of the invention, and/or at least one storage medium for maintaining the software of the invention or a database of information useful in the invention. Thus, in embodiments, the hardware of the invention is a computer, such as a network server or the like, which comprises at least one processor capable of executing computer instructions to implement the method of the invention. An exemplary piece of hardware according to the invention is an Internet appliance, such as one available from Paxfire, Inc. (Herndon, Va.), which is capable of monitoring communication traffic between a user and an ISP, or a user and the Internet, and redirecting communications to a landing page created in real-time in response or in consideration of information provided in or associated with the user's request.

In another aspect, the invention provides a system for providing an affinity program. In general, the system comprises computer software and computer hardware, and is implemented, at least in part, at the ISP level of the Internet, preferably by an ISP. The system provides the software and hardware to enable an ISP to implement an affinity program for its customers, where the affinity program provides the user search results from one or more affiliates or affiliated programs on a landing page that is generated in real-time as a result of the user's use of the affinity program. In particular, the system is capable of collecting search results from two or more affiliated affinity programs, two or more affiliated advertisers, or a combination of these, and displaying the results on a single landing page, which may contain links to each result along with advertising for products and services that are relevant to the content of the user's original search.

Accordingly, the present invention provides a method of doing business using computers, and more specifically, over the Internet. By providing a fast, convenient conduit for Internet shopping, the present invention provides a way to conduct business over the Internet. It likewise provides a way to monetize Internet traffic by providing a method for an ISP, an ISP subscriber, retailers, credit card companies, or two or more of these, to generate revenues by making sales to consumers (i.e., the ISP subscribers).

### BRIEF DESCRIPTION OF THE DRAWINGS

FIG. 1 depicts one configuration of a system according to the invention for providing an affinity program at the ISP level.

FIG. 2 depicts another configuration of a system according to the invention for providing an affinity program at the ISP level.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is provided to supply a fuller description of certain embodiments of the invention, and is not intended as a limiting disclosure of all embodiments of the invention. Rather, those of skill in the art will be able to understand the full scope of the invention after consideration of the above broad description, the following detailed description of certain embodiments, and the claims.

The present invention provides a system and method for providing an affinity or loyalty program to Internet users. The system and method are implemented at the ISP level of the Internet architecture by an ISP. That is, the system and method can be provided directly by the ISP providing Internet services to a subscriber, or by a third party that the ISP contracts with to provide the service, and that provides the service either in a seamless manner that appears as though the service is being provided by the ISP directly, or as an obvious third-party service provided by the third party for the ISP. The system and method permit ISP subscribers to opt-in to one or more affinity programs upon initiation of service with the ISP or at any time while receiving services from the ISP. Likewise, the subscriber can opt-out of one or more of the affinity programs or services within a particular program, or any part of it, at any time while a subscriber to the ISP. Each affinity program can be tailored by the ISP to suit the particular needs of its subscribers, and, as discussed below, can be tailored to each individual subscriber based on subscriber preferences and behaviors.

In a first aspect, the invention provides a method of providing an affinity or loyalty program. In general, the method comprises: obtaining or generating one or more piece of identifying information for a user; providing the user access to one or more affinity programs; and providing the user results for a search for one or more products or services from affinity program advertisers. The method generally involves implementation by an ISP or under the auspices of an ISP, and thus can further comprise providing Internet access to the user.

In the context of the method of providing an affinity program, the act of obtaining one or more piece of identifying information for a user can comprise requesting or requiring the user to provide to the ISP or an entity under the control and/or direction of the ISP, the user's name, home address, telephone number, age, sex, marital status, yearly income, social security number, credit card number, or the like. Some or all of this information is generally required by ISPs for initiation of general service, and thus requesting it would not represent anything extraordinary or inappropriate for enrollment into the affinity program of the present invention. Of course, where a user wishes to participate in the affinity program, but also wishes not to provide some or all of the personally identifying information desired by the ISP, the ISP may simply generate the desired information from its internal records for the user, based on information provided to the ISP by the user upon initiation of general ISP services.

One advantage of implementation of the method at the ISP level is that identifying information about a user can be provided by the user or obtained from ISP records relating to the user only a single time, and can be used each time the user logs on. For example, identifying information may be provided by the user at the time of initiation of service with the ISP. That information can then be retrieved automatically for each user upon log-in to the ISP service, for example at each search sessions. Accordingly, unlike many affinity programs now in use, a user need not log in to each program of interest using personally identifying information or a log-in name and password. Rather, the user will automatically be identified by the ISP upon log in, and multiple affinity networks accessed without any further log-in activity by the user.

The method comprises providing the user access to one or more affinity programs. According to the invention, an affinity program may be one instituted by the ISP, such as by developing agreements with one or more advertisers, which act as direct affiliates of the program. It likewise may be one instituted by a third party (e.g., fatwallet.com), and to which the ISP has access as a user. In preferred embodiments, the ISP has access to multiple third party affiliate programs, and provides to the user the results of searches of all such programs, as a single result page. The method thus provides the advantages of two distinct solutions for on-line shopping: those provided by third-party affinity programs, and those provided by ISP-implemented affinity programs. That is, the current state of the art permits users to access, individually and independently, numerous third-party affinity programs to find the best deal on a service or product. The current state of the art also provides ISPs with the ability to develop their own affinity programs by building a network of affiliates from which services and products may be offered to the ISPs customers. In contrast, the methods of the present invention permit an ISP to both tap into third party affinity programs and develop its own affiliate list, and provide the benefits of both to its subscribers. In preferred embodiments, the method comprises use of one or more third party affinity programs. Where the ISP develops its own affiliate network, the ISP will also provide access to at least on third party affinity program as well.

According to the method, the user is provided with results for a search for one or more products or services from affinity program advertisers. Other ISP-based solutions for affinity programs simply redirect a user from an IP address for requested web page at an advertiser's site to an IP address for the same web page, but which is associated with the affinity program. In contrast, the method of the present invention provides the user with a landing page that comprises information about the requested product or service, but is not the actual web page requested. The landing page provided by the present method can comprise one or more links to one or more web pages of interest to the user, and may comprise advertising content or other content of interest to the user, the ISP, or advertisers. Thus, in a preferred embodiment, the method further comprises creating a landing page to display the results of a search, where the landing page may comprise results from one or more affinity networks and/or advertising content or other content that might be of interest to the user. The landing page may comprise any amount or type of information, and is not limited to only information that is directly related or directly relevant to the services and/or products of interest to the user. Indeed, the landing page may comprise information that is relevant to other searches performed by the user, to current events (e.g., daily news, stock reports), and geographically-relevant information (e.g., current local weather reports, local leisure or entertainment offerings).

One advantage of the present method over prior art solutions for providing on-line shopping is that the present method allows users to search for products and services at multiple affinity programs simultaneously. That is, if a user is enrolled in multiple third party affinity programs, by way of an opt-in/opt-out mechanism provided by the ISP, the user can submit to the ISP program a single search statement and receive back offers from multiple advertisers via multiple affinity programs. All of the offers are returned on a landing page that is created within the method of the invention, providing the user the ability to easily and quickly consider all of the offers and determine the best one. According to the invention, there is no need to log into each third party program, search, then return to re-check price and availability. Instead, according to the present invention, all available (or desired) third party affinity program providers are consulted at one time, and the results for all are provided to the user in a single landing page. Of course, the landing page may also provide other information for the user, such as relevant advertising or links to related information.

In embodiments, the method of the invention is implemented by way of computer software. The computer software of the invention may be any set of instructions that can be understood and implemented by a computer. It thus may take the form of one or more computer programs and/or file sets. It can be written in any computer language, and can be provided in any form, such as in the form of source code, object code, computer code, flow diagrams, or any other means by which those in the art convey information for implementation by way of computers. In general, the software of the invention comprises instructions for implementing the methods of the invention. The software may comprise all of the instructions in a single file or program, or the instructions may be separated into multiple files or programs, which when executed in conjunction with each other, execute the method of the invention. Accordingly, portions of the software of the invention may reside on different media, and the media may be connected in any suitable fashion to achieve a functional program or suite of programs. The invention thus includes one or more computer programs for implementing the methods of the invention.

In embodiments, the invention provides, in addition to software, data files or file sets comprising information relating to the method of the invention. For example, the invention may provide one or more databases containing information regarding specific users or specific IP addresses within an ISP network, and the opt-in or opt-out status of those users for certain third party affinity programs, or the IPS affinity program in general. The database(s) may also comprise other information, such as previous search terms used by a user, frequency of access to the affinity program, and the like. The amount and type of data collected and maintained is not particularly limited, and can be selected by each ISP in accordance with its own desires and interests.

The software of the invention may be comprised on any medium that is suitable for long-term or short-term storage (and use) of software. Thus, the invention provides long-term storage media for computer programs and files, such as a hard drive, a floppy disk, an optical disk (e.g., CD, DVD), a flash drive, a USB stick (or memory stick), a magnetic tape, and the like. It also provides short-term storage media for computer programs and files, such as random access memory (RAM) and circuit boards. In some embodiments, the storage medium is a portable storage medium, which can be easily inserted into and removed from a computer, such as by way of an external socket on the computer (e.g., a USB port, a CD/DVD drive, a floppy drive).

The invention provides a method of controlling Internet communication traffic. In general, the method comprises receiving a request from a subscriber for an IP Address look-up, determining if the IP Address indicates a member of an affinity program, and connecting the requester to the IP Address by way of the affinity program, wherein the method does not comprise the subscriber logging on to any web site other than the ISP to which the subscriber subscribes. The method thus does not require the subscriber to request, by typing a URL or clicking a bookmark or favorite site stored in a memory device, a web site other than the web site of his ISP provider, as is required by current affinity programs, which are implemented by third party providers outside the purview and control of an ISP.

The invention thus provides a method for an ISP subscriber to participate in an affinity or loyalty program using the Internet. The method comprises a subscriber requesting from an ISP DNS an IP Address look-up, and having the look-up request automatically redirected from the DNS to a server that provides access to the IP Address under the provisions of an affinity program if the IP Address indicates a retailer that participates in the affinity program, where the redirection of the request does not require any further input by the ISP subscriber beyond submitting the IP Address look-up. The method can further comprise the subscriber electing to participate in the affinity program by way of the subscriber informing the ISP of the election. In addition or alternatively, the method may comprise limiting access to the program based on the ISP, rather than on choices made by the user. For example, some sites, such as, for example, ESPN 360, allow members of only certain ISPs to have access to their content. This mechanism can similarly be used to determine membership and access to content of the affinity program of the present invention. That is, membership in the program can, in embodiments, extend beyond shopping to include access to content as well.

In a second aspect, the invention provides one or more pieces of computer hardware. The hardware can comprise any number of components, but in general, it comprises a processor for executing the methods of the invention, and/or at least one storage medium for maintaining the software of the invention and/or one or more databases of information that can be used in the invention. The components of the hardware are those which can be found in the field of electronics in general, and no particular modifications are required to implement the methods of the present invention on such hardware. Electronic components and connections used in the hardware are those typically used in the computer industry, as are all other structural elements of the hardware (and systems, discussed below). As discussed herein, the methods of the invention are implemented at the level of the ISP. The hardware thus may be included as part of one or more ISP Domain Name System (DNS) servers. In these embodiments, the various pieces of hardware and software can reside on the ISP DNS server(s), on separate hardware from the ISP DNS server(s), or partially on the ISP DNS server(s) and partially on separate hardware. In certain embodiments, the methods are implemented on separate hardware from the ISP DNS server(s).

Where the hardware of the invention does not comprise any ISP DNS server(s), the hardware of the invention and the ISP DNS server(s) can be physically connected via cables, wires, or the like. The connection can be direct (i.e., from one to the other without any intervening hardware, except via the connector) or indirect (i.e., through one or more other hardware devices, such as circuit boards, filters, etc.). In other embodiments, the connection is not a physical connection (e.g., it is a connection via electromagnetic energy, such as infrared signals, radio signals, microwave signals, optical signals, and the like). In certain embodiments, the hardware is implemented directly within an ISP DNS server or a registry DNS server (e.g., by insertion of a circuit board into the server). In other embodiments, certain functionalities are implemented directly within the ISP or registry servers, while other functionalities are implemented one or more other physical components, which are connected, either physically or non-physically. In embodiments where the hardware and methods (and systems, discussed below) are integrated into the registry or ISP servers, such integration can be through physical insertion of one or more circuit boards into the server.

Thus, in embodiments, the hardware of the invention is a computer, such as a network server or the like, which comprises at least one processor capable of executing computer instructions to implement the method of the invention. An exemplary piece of hardware according to the invention is an Internet appliance, such as one available from Paxfire, Inc. (Herndon, Va.), which is capable of monitoring communication traffic between a user and an ISP, or a user and the Internet, and redirecting communications to a landing page created in real-time in response or in consideration of information provided in or associated with the user's request.

In another aspect, the invention provides a system for providing an affinity program. In general, the system comprises computer software and computer hardware, and is implemented, at least in part, at the ISP level of the Internet, preferably by an ISP or an entity under the auspices or control of an ISP. The system provides the software and hardware to enable an ISP to implement an affinity program for its customers, where the affinity program provides the user search results from one or more affiliates and/or affiliated programs, and presents those results on a landing page that is generated in real-time as a result of the user's use of the affinity program. In particular, the system is capable of collecting search results from two or more affiliated affinity programs, two or more affiliated advertisers, or a combination of these, and displaying the results on a single landing page, which may contain links to each result along with advertising for products and services that are relevant to the content of the user's original search.

In general, the system of the invention comprises one or more computer-based services provided by an ISP to its subscribers, in which the subscriber is provided the option to participate in an affinity program that provides monetary rewards for purchasing goods or services over the Internet from retailers or service providers that are part of the affinity network. Although the ISP may provide multiple such services to the subscriber according to the system, for the purpose of clarity in description, a configuration in which only one such service is provided will be discussed herein. The system generally comprises a device at a point of origin, which can be a personal computer, hand-held device with Internet capability (e.g., Blackberry®), router, hub, or any other device that can communicate with one or more servers controlled by the ISP. The device at the point of origin can represent a single or multiple computers (as in the case of a router or hub) and a single or multiple users. The system also generally comprises at least one server under the control of an ISP, where the server is capable of receiving communications from the device at the point of origin and passing those communications, either directly without viewing the content or after viewing the content and taking one or more actions, to the Internet infrastructure, and then returning communications from the Internet to the device at the point of origin. According to the present invention, the system further comprises one or more devices that analyze communications coming from the device at the point of origin and provide the affinity program services. These devices can be independent, distinct devices, or can be integrated with one or more servers of the ISP to provide multiple functions on a single piece of hardware. In preferred embodiments, the system comprises an Internet appliance, such as one commercially available from Paxfire, Inc. (Herndon, Va.).

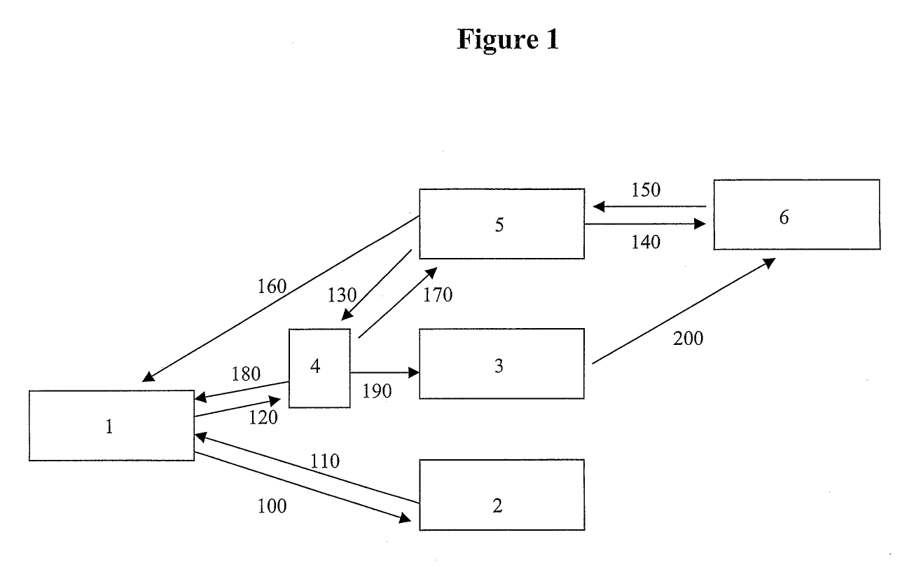

For example, a system according to the invention can comprise a Dynamic Host Configuration Protocol (DHCP) server for assigning an IP Address to a subscriber, a DNS for IP address look-ups, an Internet appliance for identifying subscribers who participate in one or more affinity programs, and a device that provides one or more affinity programs to the ISP subscribers who have elected to participate. In some embodiments, the DNS server, Internet appliance, and device that provides the affinity programs are the same device or are provided on two devices, with any combination of functions provided between the two. Such a system, is depicted in FIG. 1, which will be discussed in detail below.

As another example, the system may comprise the following: one or more small computer filed (“cookies”) to track an ISP subscriber; a DNS server for IP Address look-ups; an Internet appliance for identifying subscribers who participate in one or more affinity programs (via cookies); and a device that provides one or more affinity programs (via a web proxy server) to the ISP subscribers who have elected to participate. In this example, a cookie that identifies the user to the web server is placed on the user's computer. The web server provides to the user a framed version of the affinity web site, along with information specific to the individual subscriber. If a user does not have a cookie on his machine, the proxy asks the user if he would like to participate in the affinity program, or one or more aspects of the affinity program. If the user agrees to participate, a “positive” cookie is placed on his machine. If the user does not agree to participate, a “negative” cookie is placed on his machine. For all future search sessions, the cookie will indicate to the system the opt-in status of the user. Other information may also be included in the cookie, which can help in identifying the user to the system. If the user removes the cookie from his machine, the opt-in status and all other information will be removed; therefore, on the next log-in, the user will be requested to participate again.

In another example of a system according to the invention, the system can provide a way to track a subscriber for loyalty programs. Tracking is accomplished through use of an Internet appliance that monitors DHCP or RADIUS assignments of IP Addresses. Using unique identifiers that correspond to IP Addresses in use at any one time, the systems and methods of the invention can identify subscribers that have opted-in for the affinity program, and redirect appropriate IP Address look-up requests to an appropriate landing page for the program, while taking no action on IP Address look-up requests from ISP subscribers that have not opted-in to the affinity program, or who have opted-out of the program after participating for a period of time.

In yet another aspect, the present invention provides a method of doing business using computers, and more specifically, over the Internet. By providing a fast, convenient conduit for Internet shopping, the present invention provides a way to conduct business over the Internet. It likewise provides a way to monetize Internet traffic by providing a method for an ISP, an ISP subscriber, retailers, credit card companies, or two or more of these, to generate revenues by making sales to consumers (i.e., the ISP subscribers).

In general, the methods comprise providing an affinity or loyalty program as a service of an ISP, and generating revenue as a result of providing that service. The affinity program can be implemented in any number of ways known in the art, the specifics not being critical to practice of the invention. The methods can be implemented by ISPs to provide services to date not provided by ISPs, thus giving the ISP an advantage in the marketplace over competitors in retaining subscribers and in generating new subscribers. The methods can benefit not only the ISP that implements the methods, but also retailers that participate in the affinity program and ISP customers.

By implementing the systems and methods of the present invention, revenue can be generated by the ISP and retailers, and cost savings achieved by consumers. By implementing the systems and methods of the present invention, an ISP can generate revenue by increasing its subscriber base. Subscribers will join an ISP to obtain the benefits provided by the affinity program. An ISP can also generate revenue by selling advertising space on landing pages generated in response to IP Address look-ups for web sites of participating retailers. Finally, an ISP can generate revenue from retailers by receiving a payment for each click-through provided through its affinity program, or for each purchase made by a subscriber to the ISP's affinity program. Other methods of monetizing Internet traffic through affinity programs are known in the art, and those also can benefit an ISP implementing the systems and methods of the present invention.

By implementing the systems and methods of the invention, revenue can be generated by retailers by increasing the number of shoppers visiting a retailer's site and purchasing products or services. Revenue can also be generated by increased sales resulting from the retailer buying advertising space on landing pages provided by the ISP in response to certain IP Address look-up requests.

In addition, credit card companies, such as banks that issue credit cards, can generate revenue both by participating in the affinity program (e.g., use of a particular credit card results in a discount or other monetary reward) and by increased use of their cards by shoppers. Credit card companies have traditionally been leaders in providing affinity programs to their clients, with points being awarded for use of the card. Depending on the card and the affinity program, the points can be redeemed for products, airline travel, or cash. Their participation in the affinity program of the present invention provides the card companies an additional advantage over card companies that do not participate in affinity programs, and in particular the affinity programs provided by the present invention.

Finally, consumers can reap monetary gains by participating in the systems and methods of the present invention. Affinity programs provide monetary rewards for participation, from lowered prices for goods and services, to coupons or credits toward future purchases, to cash. Consumers who participate in the systems and methods of the present invention also benefit from not having to repeatedly move from one site to another to determine if a price for a particular item or service is discounted at the retailer—all traffic from the subscriber to the retailer will be routed through the affinity program, thus providing the subscriber with the best price without the need to enter and exit sites repeatedly. In one preferred embodiment, ISP customers are provided with free Internet access by an ISP in return for enrolling in the ISP's affinity program. In this scenario, the consumer receives the monetary gain of free Internet access (possibly in addition to monetary rewards from retailers), while the ISP receives a monetary gain by generating pay-for-performance or click-through credits from affiliate members and/or advertisers. Depending on the arrangement brokered between the ISP and its customers, the ISP may also reap all of the rebates from the affiliate members (rather than those going to the individual users/shoppers). Furthermore, as mentioned above, the system can provide access to exclusive membership content. This is a further benefit for the user, and can provide a monetary compensation for both the ISP and user, as well as increase membership in content delivery providers, thus boosting revenues for those entities as well.

Turning now to the figures, which depict certain embodiments of the systems of the invention, FIG. 1 shows, in general, communication pathways for subscribers to an ISP affinity program according to one embodiment of the present invention. More specifically, FIG. 1 depicts communications that occur during the process of on-line shopping by an ISP subscriber that participates in an affinity program that is provided by the ISP, where the ISP provides the affinity program to all of its subscribers. The subscriber 1 obtains an IP Address from the ISP DHCP server 2 via communication paths 100 and 110. The subscriber then makes an IP Address request to an ISP DNS server 3 via communication path 120. An Internet appliance 4 is interposed between the subscriber 1 and DNS server 3, and intercepts communication along pathway 120. The Internet appliance contains a database or table of all IP Address requests that correspond to web sites of participants (e.g., retailers) in the affinity program. The Internet appliance consults this table and determines if the requested IP Address is a participating site. If so, the Internet appliance 4 redirects the request to a server 5 via communication path 170. Server 5 provides a landing page for the subscriber that provides information dictated by the ISP, and which preferably includes a frame or sidebar that visually indicates to the subscriber that the subscriber is a participant in the affinity program and other information deemed of interest by the ISP. The subscriber's request is passed to the Internet, and particularly to the web site of interest 6, by communication path 140, such that the subscriber is connected to the web site of interest 6. In making the connection between subscriber 1 and the web site of interest 6, server 5 passes information to the web site of interest 6 informing it that subscriber 1 is a participant in an affinity program, and that discounts or other promotional information should be provided to that subscriber by the web site 6. The relevant information is passed back from the web site 6 to the server 5 over communication path 150, and the landing page is built. Information on the landing page is then sent back to the subscriber 1 either directly via communication path 160 or via Internet appliance 4 through communication paths 130 and 180. In the event that the original IP Address look-up request was not an IP Address of a retailer participant in the program, Internet appliance 4 passes the request to DNS 3 via communication path 190 for lookup through the Internet infrastructure by way of path 200.

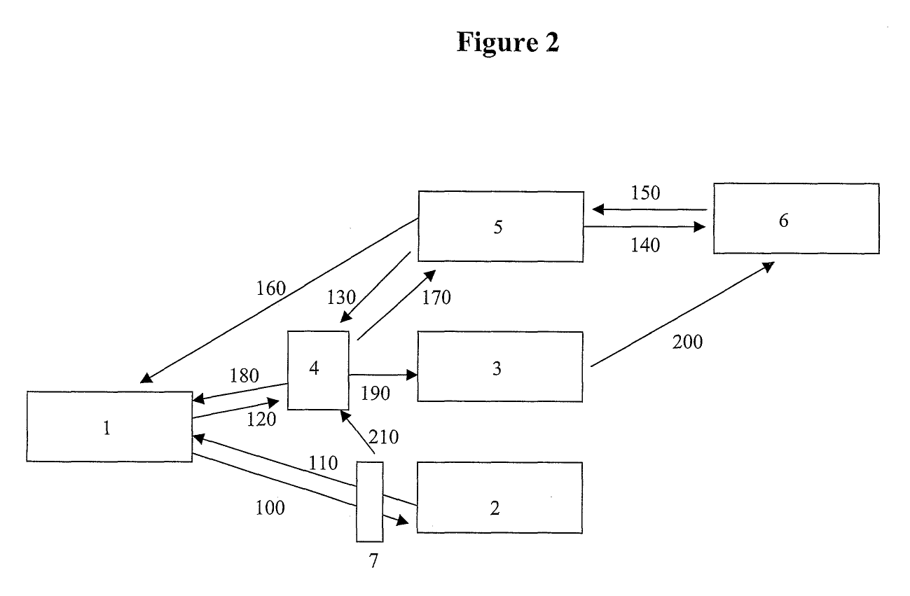

FIG. 2 depicts another configuration of an exemplary system according to the invention. In FIG. 2, a scenario for on-line shopping is depicted in which the ISP provides its subscribers the option of participating in an affinity program or foregoing the program. More specifically, FIG. 2 depicts communications that occur during the process of on-line shopping by an ISP subscriber that participates in an affinity program that is provided by the ISP. The subscriber 1 obtains an IP Address from ISP DHCP server 2 via communication paths 100 and 110. Interposed between subscriber 1 and DHCP server 2 is Internet appliance 7, which monitors communications between subscriber 1 and DHCP server 2 to correlate a unique identifier for subscriber 1 and the IP Address assigned to that subscriber by DHCP server 2. Information about that correlation is passed to Internet appliance 4 by way of communication path 210.

Subscriber 1 then makes an IP Address request to ISP DNS server 3 via communication path 120. Internet appliance 4 is interposed between subscriber 1 and DNS server 3, and intercepts communication along pathway 120. Internet appliance 4 contains a database or table of all IP Address requests that correspond to web sites of participants (e.g., retailers) in the affinity program. It also contains a table or database containing a list of subscribers that participate in the affinity program. It further contains a table correlating unique identifiers that identify each subscriber of the ISP and the IP Address currently being used by that subscriber (information supplied to it by Internet appliance 7 via path 210). Internet appliance 4 consults the table containing IP Addresses of retailers that participate in the affinity program. If the requested IP Address is not a participating site, the IP Address request is passed to DNS server 3 via path 190, and an IP Address look-up is performed via the Internet. If the requested IP Address is an address of a participating retailer, Internet appliance 4 consults the table that correlates IP Address with unique identifier so as to identify the particular subscriber associated with the IP Address from which the request came. Internet appliance 4 also consults the table of participating IPS subscribers in the affinity program. Internet appliance 4 compares the subscriber associated with the IP Address of the request with the list of participating affinity program subscribers. If the subscriber making the IP Address look-up request participates in the program, the request is redirected to a server 5 via communication path 170. Server 5 provides a landing page for subscriber 1 that provides information dictated by the ISP, and which preferably includes a frame or sidebar that visually indicates to the subscriber that the subscriber is a participant in the affinity program, and other information deemed of interest by the ISP. The subscriber's request is passed to the Internet, and particularly to the web site of interest 6, by communication path 140, such that subscriber 1 is connected to web site of interest 6. In making the connection between subscriber 1 and web site of interest 6, server 5 passes information to web site of interest 6, informing it that subscriber 1 is a participant in an affinity program, and that discounts or other promotional information should be provided to that subscriber by web site 6. The relevant information is passed back from web site 6 to server 5 over communication path 150, and a landing page is built. Information on the landing page is then sent back to subscriber 1 either directly via communication path 160 or via Internet appliance 4 through communication paths 170 and 180. If the subscriber making the IP Address look-up request does not participate in the affinity program, Internet appliance 4 passes the request to DNS server 3 via communication path 190 for lookup through the Internet infrastructure by way of path 200.

The configurations depicted in FIGS. 1 and 2 can be modified in numerous ways to achieve the same result. For example, Internet appliance 4 and DNS server 3 can be combined into a single device; Internet appliance 4 and Internet appliance 7 can be combined into a single device, alone or in combination with DNS server 3 and/or DHCP server 2; server 5 can be combined with DNS server 3 or Internet appliance 7; and other combinations of hardware can be established. Likewise, each function provided by each piece of hardware can be implemented on any other piece of hardware in the system, alone or in any combination with any other function or software.

Exemplary Internet appliances 4 and 7 are disclosed in co-pending U.S. patent application Ser. No. 11/019,369, as are various advantages of such appliances. The entire disclosure of this co-pending U.S. application is incorporated herein by reference.

Currently, ISPs have not implemented any type of reward or loyalty marketing program. The present invention provides that service and a convenient, competitive way to implement it. As mentioned above, there are numerous Internet-based loyalty programs, such as FatWallet. These programs require a user to log in and shop at a mall portal site, and to access stores only through the mall. In such a system, it is very inconvenient for customers to claim discounts or points and to redeem them because they must always remember to log into the mall to take advantage of the discounts. Such a system also makes it difficult for customers to know if they could get a discount if they were to go to the retailer's site directly. Thus, users of the loyalty marketing programs must visit sites of interest outside of the context of the program, then visit the sites of interest from within the program to determine the best available price. This inefficiency reveals untapped opportunities for ISPs to provide loyalty programs to consumers. It also reveals opportunities for advertisers to attract, retain, and grow their customer base through loyalty programs that motivate desired behaviors and truly create loyal customers without the hassle of customers having to track points, discounts, know which credit card purchases offer points or know what online stores offer points or discounts, or having to log into a portal. According to the present invention, all of those activities can be monitored and provided to the subscribers/customers by the ISP through use of its servers and Internet appliances.

By implementing the systems and methods of the present invention, subscribers to ISPs can enjoy the benefits of loyalty programs with ease and comfort, which in turn creates goodwill and loyalty between a customer and an ISP, and solidifies the subscriber as a long-term subscriber to the ISP. Users can also profit through the use of the systems, either through reduced or eliminated ISP subscriber fees, and/or through monetary rewards for shopping on-line.

As more companies and new industries begin offering loyalty programs, consumers are going to become even choosier about the programs in which they will participate. However, if ISPs give consumers an easier way to use rewards programs that affect consumer behavior, then ISP subscribers (as a membership group) will be more loyal to companies that offer rewards programs. Such an outcome is advantageous to the companies (i.e., the participating retailers).

One key to a successful loyalty program lies in using analytics and modeling tools to ensure that the right rewards are offered to the right customers and are achievable within a reasonable amount of time. The present invention provides these abilities and tools as part of the ISP hardware or software, or as part of the services provided by the ISP by way of an integrated service provided by a third party who is under an obligation (e.g., under contract) to provide the services to the ISP. Most programs are designed so that the most profitable customers earn enough points for redemption within 120 days, and the majority of customers earning enough points to redeem in approximately 9 months. The systems and methods of the invention can provide such a redemption plan, or another that is better suited to the subscriber base of a particular ISP. Furthermore, because the present systems and methods can be tailored to individual subscribers of an ISP, reward choices can be tailored to particular subscribers.

The top reason cited for consumers to participate in a rewards program is to receive discounts on purchases of goods and services. The next three most popular reasons are cash back, merchandise, and certificates. Households with an income of less than $60,000 and greater than $125,000 generally prefer cash back and discounts, and higher income households are significantly more likely to prefer perks. When it comes time to collect their rewards, most consumers choose to redeem their points for gift certificates according to actual customer behavior tracked in loyalty marketing programs. The present systems provides the ability to track behavior of individual subscriber without the need to request any information beyond that which is provided upon initiation of service from the ISP (although further information may be requested in certain embodiments). Thus, the systems and methods of the present invention can be implemented without the need for cookies to be placed on a subscriber's machine. Alternatively, in some embodiments, additional benefits can be provided by placing cookies or other identifying information on a subscribers computer.

When comparing members within a loyalty program, research shows that members who redeem points for rewards spend 3 times as much as those who do not redeem points. Only 4 percent of redeemers leave a loyalty program, as compared to 11 percent of non-redeemers. Therefore, it is in the best interest of loyalty program managers to engage the customer in point redemption, which can be easily accomplished through use of the present invention by providing a framed landing page to consumers when they go to a participating site. For example, if a consumer goes to amazon.com, and amazon.com is a participating retailer in an affinity program available from the ISP, then the systems and methods of the invention will redirect the user to a landing page using an Internet appliance that is capable of doing so. When the user buys something at amazon.com, the additional discount information is available on the landing page. This makes redemption easy for the customer, a facet of Internet commerce that is important because most users of loyalty programs prefer to redeem via the Internet. This is a positive trend in the industry, creating a win-win situation for the companies that are members of the loyalty programs, credit card companies, the ISPs, and the consumers. The consumer wins, at least in part, because of the convenience of Internet orders. The credit card issuer wins because this is one of the most cost effective ways to process an order for redemption.

Allowing loyalty program members to create a “wish list” also helps to drive loyalty. When asked about looking for rewards, consumers who are more loyal to companies are earning with a specific reward in mind. Consumers who are aspiring to a reward also claim that the programs have a great deal of influence on their purchase decisions, which puts certain credit cards at the top of the wallet. Thus, in embodiments, the present invention permits subscribers to create a wish list for reward redemption. The wish list may be maintained as part of a database and placed on the landing page for viewing by the user each time he searches for products or services using the affinity program.

Once a credit card company knows what the customer's wish list is, frequent communication about reward choices can encourage spending and point earnings to achieve the reward sooner. Most people prefer to be updated about their rewards programs through the Internet. This trend is even more common among customers in the 18-24 age groups. Most survey respondents in this age bracket say they prefer communication via the Internet, and some of them have stopped participating in a rewards program because they received too much mail from a company. Thus, in embodiments, the present invention includes maintaining a current total of points earned through the affinity program, presenting that total to subscribers each time they log on to the Internet through their ISP, and/or sending e-mail messages to the subscriber to periodically apprise him of his point total.

With complex rewards programs, it is important to understand consumer behavior patterns and motivations, otherwise programs could fail to accomplish their intended goals. The systems and methods of the present invention can track all types of behavior patterns, and use that information to achieve goals. For example, the systems and methods of the invention can provide a program that customizes potential rewards based upon the individual subscriber's/customer's hobbies and interests, a feature that will vastly increase reward program satisfaction. Along this line, it is believed to be important that companies avoid making assumptions about their target audience's preferences and desires, and rather employ a strategic approach to truly understand customer behavior. Only then are companies in a position to develop customized, robust rewards programs that increase customer loyalty and satisfaction. The present invention can enable an ISP to implement such a strategic approach by maintaining databases of subscriber activity and purchases. For example, the present systems and methods can be implemented in such a way that a database is kept on an Internet appliance, where the database contains a list of all domain names of companies that are participants in a particular loyalty program. When a subscriber requests an IP Address look-up from the ISP DNS, the Internet appliance redirects the subscriber to a landing page. At the landing page, the site (e.g., amazon.com) will be framed with the discounts for that site automatically showing up. In addition, a cookie can be placed and retained on the landing page, which will be checked and updated every time the subscriber lands on the landing page, even when the subscriber makes an error and arrives at the landing page unintentionally. Then the landing page server can communicate back to the Internet appliance to let it know the IP Address of active participants. Those who are not members of the loyalty program are not sent to a landing page.

Those of skill in the art will immediately realize that the present invention may be embodied as a method, a computer program product, a computer system, and a method of doing business. Accordingly, the present invention may be provided entirely as hardware, entirely as software, or as a combination of software and hardware. It should also be apparent that the present invention may be provided as a computer program product on a computer-readable storage medium, such as that having a computer-readable program. Means for implementing the methods, programs, hardware, and systems are provided.

The present invention has been described at times above with reference to block diagrams and flowcharts. It is to be understood that each block of the block diagrams and flowcharts can be implemented by computer program instructions (i.e., software), which may be comprises on a general purpose computer, special purpose computer, or other programmable data processing apparatus to produce a machine or device. Execution of the instructions on the machine or device provides a means for implementing functions depicted in the diagrams and/or flowcharts.

The computer programs disclosed herein are capable of being stored in computer-readable storage (e.g., in memory or on disk), which, when present in the memory of a computer, can direct the computer to function in a particular manner. The combination of the program and hardware, in embodiments, provide an article of manufacture, which includes instruction means that implement the functions described with regard to the methods of the invention, and which, in embodiments, are depicted in the figures. It thus should be apparent that blocks of the diagrams and flowcharts depict combinations of means for performing the various functions described herein. They also depict combinations of steps for performing the various functions. They further can be understood to depict program instruction means for performing the various functions.

It will be apparent to those skilled in the art that various modifications and variations can be made in the practice of the present invention and in construction of the system and its component devices and software without departing from the scope or spirit of the invention. Other embodiments of the invention will be apparent to those skilled in the art from consideration of the specification and claims, and from practice of the invention. It is intended that the specification be considered as exemplary only.

1. A computer system for providing an affinity program from a network service provider, the system comprising:
an affinity program that comprises at least one affinity program member having at least one affiliate advertiser;
a first Internet appliance that provides a redirect IP address in response to a request from a subscriber for a URL, a web site, or a search word or term;
a server at the redirect IP address that provides a landing page comprising search results from the affiliate advertiser(s); and
a second Internet appliance that monitors IP address assignments from the network service provider to subscribers and passes information correlating IP addresses and unique identifying information for subscribers to the first Internet appliance.

2. The system of claim 1, further comprising a subscriber who submits the request.

3. The system of claim 1, wherein the request is for a product or service, and wherein the landing page comprises links to one or more products or services available from one or more of the affiliate advertisers of the at least one affinity program member.

4. The system of claim 1, wherein the landing page is generated in real time as a result of the request.

5. The system of claim 1, wherein the system is under the control, either directly or indirectly, of the network service provider.

6. The system of claim 1, wherein the landing page provides the subscriber search results from two or more affinity program members.

7. The system of claim 6, wherein the subscriber does not need to log on to each affinity program member manually and/or individually in order to receive the results from each affinity program member.

8. The system of claim 1, further comprising providing monetary rewards to the subscriber for a purchase made from an affiliate advertiser of the an affinity program member.

9. (canceled)

10. The system of claim 1, wherein the first Internet appliance is provided and maintained by a third party, and controlled by the network service provider by way of contractual obligations between the network service provider and the third party.

11. The system of claim 1, wherein the network service provider is an Internet Service Provider (ISP).

12. A method of providing an affinity program to a network service provider subscriber, said method comprising:
providing a subscriber to a network service provider the ability to receive affinity program services from one or more affinity program members,
wherein the affinity program members are managers of affinity programs not under the control of the network service provider;
providing affinity program services users access to one or more affinity program services without requiring the users to manually provide account information to access the services; and
providing a landing page that comprises affinity program services in response to a user's request for services;
wherein providing the subscriber affinity program services includes monitoring IP address assignments from the network service provider to users and correlating IP addresses with unique identifying information for the users.

13. The method of claim 12, wherein the landing page comprises links from two or more affinity program services, and wherein the user may access information at web sites represented by those links without having to log into the web sites represented by those links.

14. The method of claim 12, wherein the landing page is generated in real time as a result of the request.

15. (canceled)

16. The method of claim 12, wherein the network service provider is an ISP.

17. A computer program implementing the method of claim 12.

18. A computer comprising:
at least one processor; and
the computer program of claim 17.

19. A method of doing business using a computer, said method comprising:
providing an affinity program to a network service provider subscriber,
wherein the affinity program is provided by the subscriber's network service provider, and wherein the affinity program comprises providing the subscriber the ability to receive affinity program services from one or more affinity program members, wherein the affinity program members are managers of affinity programs not under the control of the network service provider; and
generating revenue from an Internet search performed by the subscriber;
wherein the step of providing an affinity program includes monitoring IP address assignments from the network service provider to users and correlating IP addresses with unique identifying information for the users.

20. The method of claim 19, further comprising:
providing the subscriber a landing page comprising information relevant to the Internet search.

21. The method of claim 19, wherein the revenue is generated by the network service provider through an increase in subscribers to the network service provider services.

22. The method of claim 19, wherein the revenue is generated by the network service provider by receiving a percentage of the sale of purchases made by subscribers through the affinity program.

23. The method of claim 19, wherein the revenue is generated by the network service provider by selling advertising space on a landing page that is generated in response to an Internet search performed by the subscriber.

24. The method of claim 19, wherein the revenue is generated by retailers through sales of goods or services through the affinity program.

25. The method of claim 19, wherein the revenue is generated by the affinity program for the subscriber based on purchases made by the subscriber.

26. The method of claim 19, wherein the network service provider is an ISP.
